(19) United States
(12) Patent Application Publication
(10) Pub. No.: US 2021/0326702 A1
(43) Pub. Date: Oct. 21, 2021

(54) PROCESSING DEVICE FOR EXECUTING CONVOLUTIONAL NEURAL NETWORK COMPUTATION AND OPERATION METHOD THEREOF

(71) Applicant: Igistec Co., Ltd., Hsinchu City (TW)

(72) Inventor: Wei-Han Cheng, Hsinchu City (TW)

(73) Assignee: Igistec Co., Ltd., Hsinchu City (TW)

(21) Appl. No.: 17/226,106

(22) Filed: Apr. 9, 2021

Related U.S. Application Data
(60) Provisional application No. 63/011,314, filed on Apr. 17, 2020.

(30) Foreign Application Priority Data
Feb. 4, 2021 (CN) 202110158649.6

(51) Int. Cl. G06N 3/08; G06F 9/54; G06N 3/063

(52) U.S. Cl. CPC G06N 3/08; G06N 3/063; G06F 9/542

(57) ABSTRACT

A processing device for executing convolution neural network computation and an operation method thereof are provided. The convolution neural network computation includes a plurality of convolutional layers. The processing device includes an internal memory and a computing circuit. The computing circuit executes convolution computation of each convolutional layer. The internal memory obtains weight data of a first convolutional layer from an external memory, and the computing circuit uses the weight data of the first convolutional layer to execute the convolution computation of the first convolutional layer. During a period when the computing circuit is executing the convolution computation of the first convolutional layer, the internal memory obtains weight data of a second convolutional layer from the external memory, so as to overwrite the weight data of the first convolutional layer with the weight data of the second convolutional layer.

### CROSS-REFERENCE TO RELATED APPLICATION

This application claims the priority benefit of U.S. application Ser. No. 63/011,314, filed on Apr. 17, 2020 and China application serial no. 202110158649.6, filed on Feb. 4, 2021. The entirety of each of the above-mentioned patent applications is hereby incorporated by reference herein and made a part of this specification.

### BACKGROUND

### Technical Field

The disclosure relates to a calculation device, and more particularly to a processing device for executing convolutional neural network computation and an operation method thereof.

### Description of Related Art

Artificial intelligence has developed rapidly in recent years, and has greatly affected people's lives. The development of artificial neural networks, especially the convolutional neural network (CNN), in many applications is becoming increasingly mature, such as being widely used in the field of computer vision. As the application of the convolutional neural network becomes more and more widespread, more and more chip designers have begun to design processing chips for executing convolutional neural network computation. The processing chips that execute convolutional neural network computation require complex computation and a huge amount of parameters for analyzing input data. For the processing chips for executing convolutional neural network computation, in order to accelerate the processing speed and reduce the power consumption caused by repeated access to the external memory, an internal memory (also known as an on-chip memory) is generally disposed inside the processing chip to store temporary calculation results and weight data required for convolution computation. However, relatively, when an internal memory with high storage capacity is required for storing all weight data, the cost and the power consumption of the processing chip also increase.

### SUMMARY

In view of this, the disclosure provides a processing device for executing convolutional neural network computation and an operation method thereof, which can reduce a capacity requirement of an internal memory in the processing device, thereby reducing power consumption and cost of the processing device.

The embodiment of the disclosure provides a processing device for executing convolutional neural network computation. The convolutional neural network computation includes a plurality of convolutional layers. The processing device includes an internal memory and a computing circuit. The computing circuit is coupled to the internal memory and executes convolution computation of each convolutional layer. The internal memory obtains weight data of a first convolutional layer in the convolutional layers from an external memory, and the computing circuit uses the weight data of the first convolutional layer to execute the convolution computation of the first convolutional layer. During a period when the computing circuit is executing the convolution computation of the first convolutional layer, the internal memory obtains weight data of a second convolutional layer in the convolutional layers from the external memory, so as to overwrite the weight data of the first convolutional layer with the weight data of the second convolutional layer.

The embodiment of the disclosure provides an operation method of a processing device for executing convolutional neural network computation. The convolutional neural network computation includes a plurality of convolutional layers. The method includes the following steps. Weight data of a first convolutional layer in the convolutional layers is obtained from an external memory by an internal memory, and the weight data of the first convolutional layer is used to execute convolution computation of the first convolutional layer by a computing circuit. Next, during a period when the convolution computation of the first convolutional layer is being executed, weight data of a second convolutional layer in the convolutional layers is obtained from the external memory by the internal memory, so that the weight data of the first convolutional layer is overwritten with the weight data of the second convolutional layer.

Based on the above, in the embodiments of the disclosure, the internal memory first obtains the weight data of the first convolutional layer from the external memory, and the computing circuit uses the weight data of the first convolutional layer obtained from the internal memory to execute the convolution computation of the first convolutional layer. Next, the internal memory further obtains the weight data of the second convolutional layer in the convolutional layers from the external memory, so as to overwrite the weight data of the first convolutional layer with the weight data of the second convolutional layer. Therefore, when the processing device is in a process of executing the convolutional neural network computation, the weight data required for the convolutional neural network computation may be sequentially written into the internal memory of the processing device in batches. Hence, a storage capacity requirement of the internal memory disposed in the processing device may be reduced, and thereby saving the hardware cost and circuit area of the processing device.

In order to make the aforementioned features and advantages of the disclosure more comprehensible, embodiments accompanied with drawings are described in detail below.

### BRIEF DESCRIPTION OF THE DRAWINGS

FIG. 1 is a schematic view of a computing system executing convolutional neural network computation according to an embodiment of the disclosure.

FIG. 2 is a schematic view of a convolutional neural network model according to an embodiment of the disclosure.

FIG. 3 is a schematic view of convolution computation according to an embodiment of the disclosure.

FIG. 4 is a schematic view of a processing device according to an embodiment of the disclosure.

FIG. 5 is a schematic flowchart of an operation method of a processing device according to an embodiment of the disclosure.

FIG. 6A is a schematic view of updating weight data in an internal memory according to an embodiment of the disclosure.

FIG. 6B is a schematic view of updating weight data in an internal memory according to an embodiment of the disclosure.

FIG. 6C is a schematic view of updating weight data in an internal memory according to an embodiment of the disclosure.

### DESCRIPTION OF THE EMBODIMENTS

In order to make the content of the disclosure more comprehensible, the following specific embodiments are illustrated as examples of the actual implementation of the disclosure. In addition, wherever possible, elements/components/steps with the same reference numerals in the drawings and embodiments represent the same or similar parts.

It should be understood that when an element such as a layer, a film, an area, or a substrate is indicated to be “on” another element or “connected to” another element, the element may be directly on the other element or connected to the other element, or there may be an intermediate element. In contrast, when an element is indicated to be “directly on another element” or “directly connected to” another element, there is no intermediate element. As used herein, “connection” may indicate physical and/or electrical connection. Furthermore, for “electrical connection” or “coupling”, there may be another element between two elements.

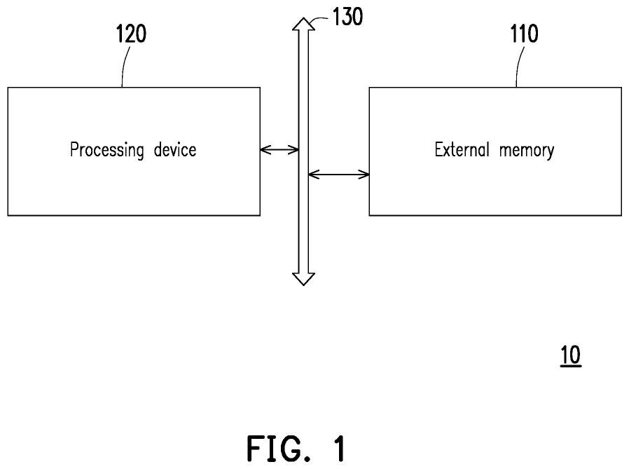

FIG. 1 is a schematic view of a computing system executing convolutional neural network computation according to an embodiment of the disclosure. Referring to FIG. 1, a computing system 10 may analyze input data based on the convolutional neural network computation to extract valid information. The computing system 10 may be installed in various electronic terminal equipment to implement various different application functions. For example, the computing system 10 may be installed in a smart phone, a tablet computer, a medical equipment, or a robot equipment, but the disclosure is not limited thereto. In an embodiment, the computing system 10 may analyze a fingerprint image or a palmprint image sensed by a fingerprint sensing device based on the convolutional neural network computation, so as to obtain information related to the sensed fingerprint.

The computing system 10 may include a processing device 110 and an external memory 120. The processing device 110 and the external memory 120 may communicate via a bus 130. In an embodiment, the processing device 110 may be implemented as a system chip. The processing device 110 may execute convolutional neural network computation according to the received input data. The convolutional neural network computation includes a plurality of convolutional layers. The convolutional layers include at least a first convolutional layer and a second convolutional layer. It should be noted that the disclosure does not limit a neural network model corresponding to the convolutional neural network computation. The neural network model may be any neural network model including a plurality of convolutional layers, such as a GoogleNet model, an AlexNet model, a VGGNet Model, a ResNet model, a LeNet model, and other convolutional neural network models.

The external memory 120 is coupled to the processing device 110, and serves to record various parameters, such as weight data of each convolutional layer and the like, that are required for the processing device 110 to execute the convolutional neural network computation. The external memory 120 may include a dynamic random access memory (DRAM), a flash memory, or other memories. The processing device 110 may read the various parameters required for executing the convolutional neural network computation from the external memory 120, so as to execute the convolutional neural network computation on the input data.

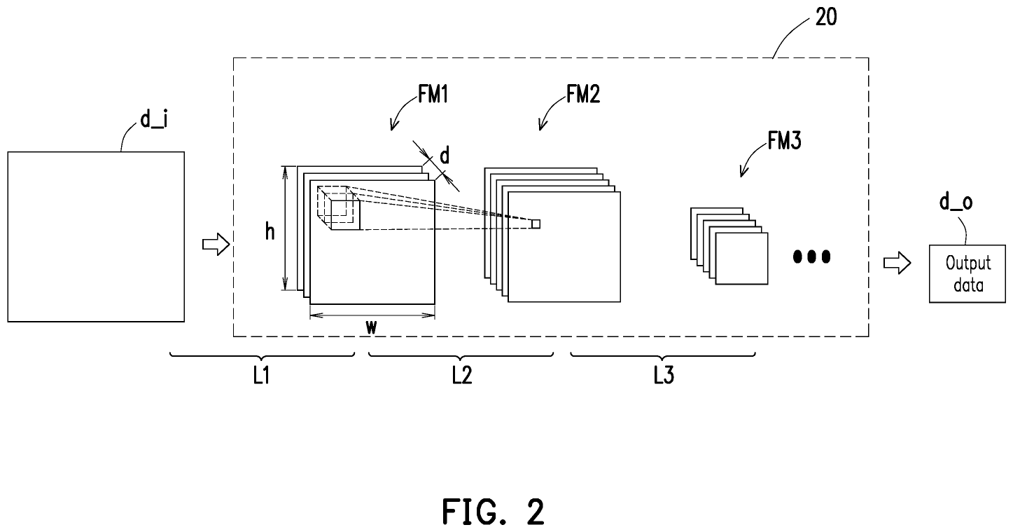

FIG. 2 is a schematic view of a convolutional neural network model according to an embodiment of the disclosure. Referring to FIG. 2, the processing device 110 may input input data d_i to a convolutional neural network model 20 to generate output data d_o. In an embodiment, the input data d_i may be a grayscale image or a color image. On the other hand, the input data d_i may be a fingerprint sensing image or a palmprint sensing image. The output data d_o may be a classification category which classifies the input data d_i, a segmented image which has undergone semantic segmentation, image data which have undergone image processing (e.g., style conversion, image filling, resolution optimization, etc.), and so on, but the disclosure is not limited thereto.

The convolutional neural network model 20 may include a plurality of layers, and the layers may include a plurality of convolutional layers. In some embodiments, the layers may further include a pooling layer, an activation layer, a fully connected layer, and the like, but the disclosure is not limited thereto. Each layer in the convolutional neural network model 20 may receive the input data d_i or a feature map generated by a previous layer, so as to execute relative computational processing to generate an output feature map or the output data d_o. Here, the feature map serves to express data of various features of the input data d_i, and may be in the form of a two-dimensional matrix or a three-dimensional matrix (also called a tensor).

For the convenience of description, FIG. 2 only shows the convolutional neural network model 20 including convolutional layers L1 to L3 as an example for description. As shown in FIG. 2, feature maps FM1, FM2, and FM3 generated by the convolutional layers L1 to L3 are in the form of a three-dimensional matrix. In the embodiment, the feature maps FM1, FM2, and FM3 may have a width w (or called a row), a height h (or called a column), and a depth d (or called a number of channels).

The convolutional layer L1 may generate the feature map FM1 by performing the convolution computation on the input data d_i according to one or more convolution kernels. The convolutional layer L2 may generate the feature map FM2 by performing the convolution computation on the feature map FM1 according to one or more convolution kernels. The convolutional layer L3 may generate the feature map FM3 by performing the convolution computation on the feature map FM2 according to one or more convolution kernels. The convolution kernels used by the convolutional layers L1 to L3 may also be called the weight data, and may be in the form of a two-dimensional matrix or a three-dimensional matrix. For example, the convolutional layer L2 may perform the convolution computation on the feature map FM1 according to a convolution kernel WM. In some embodiments, the number of channels of the convolution kernel WM is the same as the depth of the feature map FM1. The convolution kernel WM slides in the feature map FM1 according to a fixed step length. When the convolution kernel WM shifts, each weight included in the convolution kernel WM is multiplied by all feature values of an overlapping area on the feature map FM1 and then added together. Since the convolutional layer L2 performs the convolution computation on the feature map FM1 according to the convolution kernel WM, a feature value corresponding to a channel in the feature map FM2 may be generated. FIG. 2 only takes the single convolution kernel WM as an example for illustration, but the convolutional layer L2 may actually perform the convolution computation on the feature map FM1 according to a plurality of convolution kernels, so as to generate the feature map FM2 having a plurality of channels.

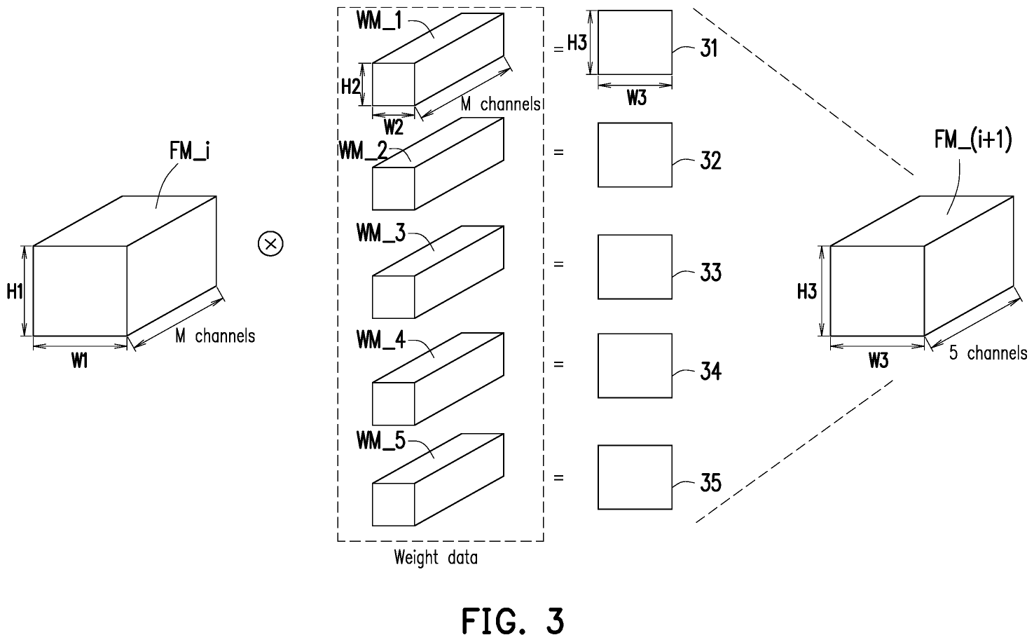

FIG. 3 is a schematic view of convolution computation according to an embodiment of the disclosure. Referring to FIG. 3, it is assumed that a certain convolutional layer performs the convolution computation on a feature map FM_i generated by the previous layer, and that the certain convolutional layer has 5 convolution kernels WM_1 to WM_5. The convolution kernels WM_1 to WM_5 are the weight data of the certain convolutional layer. The feature map FM_i has a height H1, a width W1, and M channels. The convolution kernels WM_1 to WM_5 have a height H2, a width W2, and M channels. The certain convolutional layer uses the convolution kernel WM_1 and the feature map FM_i to perform the convolution computation to obtain a sub-feature map 31 belonging to a first channel in a feature map FM_(i+1). The certain convolutional layer uses the convolution kernel WM_2 and the feature map FM_i to perform the convolution computation to obtain a sub-feature map 32 belonging to a second channel in the feature map FM (i+1), and so on and so forth. Since the convolutional layer has the 5 convolution kernels WM_1 to WM_5, sub-feature maps 31 to 35 respectively corresponding to the convolution kernels WM_1 to WM_5 may be generated, thereby generating the feature map FM (i+1) having a height H3, a width W3, and 5 channels.

According to the description of FIG. 2 and FIG. 3, the processing device 110 for executing the convolutional neural network computation needs to perform the convolution computation according to the weight data. In some embodiments, the weight data may be stored in the external memory 120 in advance. The external memory 120 may provide the weight data to the processing device 110. That is, an internal memory built in the processing device 110 may serve to store the weight data provided by the external memory 120. It should be noted that since the processing device 110 performs the convolution computation layer by layer, the weight data required for executing the convolutional neural network computation may be sequentially written into the internal memory of the processing device 110 in time-sharing batches, so that the storage capacity requirement of the internal memory may be reduced. Embodiments are exemplified below for clear description.

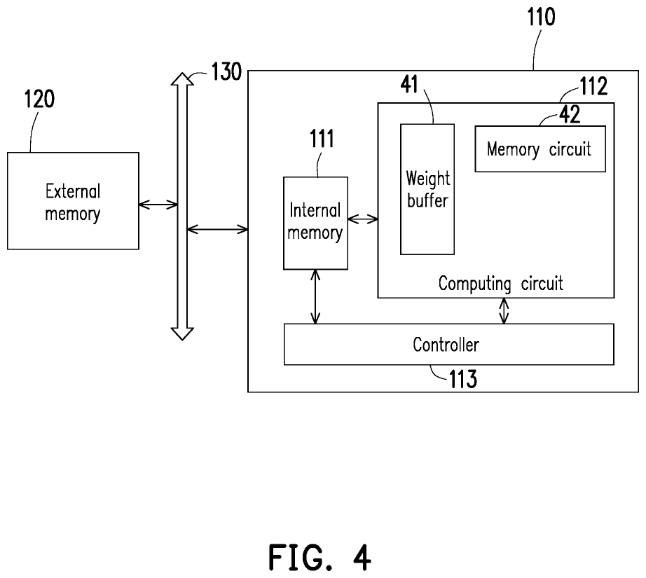

FIG. 4 is a schematic view of a processing device according to an embodiment of the disclosure. Referring to FIG. 4, the processing device 110 may include an internal memory 111, a computing circuit 112, and a controller 113. The internal memory 111 is also called an on-chip memory, and may include a static random access memory (SRAM) or other memories. The internal memory 111 is coupled to the computing circuit 112. In some embodiments, storage capacity of the internal memory 111 is smaller than storage capacity of the external memory 120, and an access speed of the internal memory 111 is faster than an access speed of the external memory 120.

The computing circuit 112 serves to execute layer computation of the plurality of layers in the convolutional neural network computation, and may include an arithmetic logic circuit for completing various layer computations. In addition, the computing circuit 112 may include an arithmetic logic circuit, such as a multiplier array, an accumulator array, and the like, that serves to complete convolution computation. In addition, the computing circuit 112 may include a weight buffer 41. The weight buffer 41 serves to temporarily store the weight data provided by the internal memory 111, so that the arithmetic logic circuit in the computing circuit 112 may efficiently perform the convolution computation. In some embodiments, the computing circuit 112 may further include a memory circuit 42 that serves to temporarily store an intermediate computation result. The memory circuit 42, for example, may be implemented by a flip-flop circuit. However, in some embodiments, the computing circuit 112 may not include the memory circuit that serves to temporarily store the intermediate computation result.

The controller 113 may be implemented by a central processing unit (CPU), a microprocessor, an application-specific integrated circuit (ASIC), a digital signal processor (DSP), or other computing circuits, and may control an overall operation of the processing device 110. The controller 113 may manage computation parameters, such as the weight data, that are required for the convolutional neural network computation, so that the processing device 110 may normally execute the computation of each layer in the convolutional neural network computation. In some embodiments, the controller 113 may control the internal memory 111 to obtain the weight data of different convolutional layers from the external memory 120 at different time points. For example, the controller 113 may control the internal memory 111 to obtain the weight data of the first convolutional layer from the external memory 120 at a first time point, and control the internal memory 111 to obtain the weight data of the second convolutional layer from the external memory 120 at a second time point. The first time point is different from the second time point. At the second time point, the weight data of the first convolutional layer in the internal memory 111 is replaced with the weight data of the second convolutional layer.

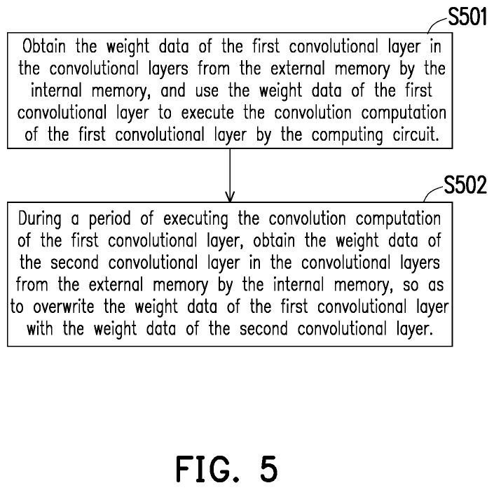

FIG. 5 is a schematic flowchart of an operation method of a processing device according to an embodiment of the disclosure. The method shown in FIG. 5 may be applied to the processing device 110 shown in FIG. 4. Referring to FIG. 4 and FIG. 5, in Step S501, the weight data of the first convolutional layer in the convolutional layers is obtained from the external memory 120 by the internal memory 111, and the weight data of the first convolutional layer is used to execute the convolution computation of the first convolutional layer by the computing circuit 112. The weight data of the first convolutional layer may include at least one convolution kernel of the first convolutional layer, and the computing circuit 112 may use the weight data of the first convolutional layer to execute the convolution computation of the first convolutional layer to obtain at least one feature map corresponding to the at least one convolution kernel.

Specifically, the weight data of the first convolutional layer may include a weight value of one or more convolution kernels. Under a condition that the internal memory 111 has all or a part of the weight values of the one or more convolution kernels of the first convolutional layer, the internal memory 111 provides the weight values to the weight buffer 41 in the computing circuit 112. Accordingly, other arithmetic logic circuits of the computing circuit 112 may execute the convolution computation of the first convolutional layer on the feature map or the input data generated by the previous layer according to the weight data of the first convolutional layer recorded by the weight buffer 41, so as to generate the output feature map of the first convolutional layer.

In Step S502, during a period of executing the convolution computation of the first convolutional layer by the computing circuit 112, the weight data of the second convolutional layer in the convolutional layers is obtained from the external memory 120 by the internal memory 111, so that the weight data of the first convolutional layer is overwritten with the weight data of the second convolutional layer. More specifically, after the weight data of the first convolutional layer recorded by the internal memory 111 is written into the weight buffer 41, the weight data of the first convolutional layer in the internal memory 111 may be cleared and a storage space may be freed up. Therefore, the storage space in the internal memory 111 that originally serves to store the weight data of the first convolutional layer may serve to store the weight data of the second convolutional layer.

In other words, after the weight data of the first convolutional layer recorded by the internal memory 111 is written into the weight buffer 41, the computing circuit 112 may execute the convolution computation of the first convolutional layer according to the weight data retained in the weight buffer 41, and the internal memory 111 may overwrite the weight data of the first convolutional layer with the weight data of the second convolutional layer obtained from the external memory 120. Accordingly, in some embodiments, the internal memory 111 is already recorded with the weight data of the second convolutional layer after the computing circuit 112 completes the convolution computation of the first convolutional layer, so that the computing circuit 112 may continue to perform the convolution computation of the second convolutional layer. Thus, the weight data belonging to different convolutional layers are written into the same storage space of the internal memory 111 at different time points, which may greatly reduce the storage space requirement of the internal memory 111 without affecting the calculation efficiency of the computing circuit 112.

In some embodiments, the controller 113 may control the internal memory 111 to obtain the weight data of the second convolutional layer from the external memory 120 in response to a notification signal sent by the computing circuit 112. In an embodiment, after the internal memory 111 provides the weight data of the first convolutional layer to the weight buffer 41, the computing circuit 112 may send the notification signal to the controller 113. In other words, the computing circuit 112 may send the notification signal to the controller 113 in response to the weight data of the first convolutional layer being already written into the weight buffer 41. The controller 113 may send a read command that serves to read the weight data of the second convolutional layer to the external memory 120 in response to receiving the notification signal.

According to the description of the aforementioned embodiment, the weight data required for the convolutional neural network computation are batched and sequentially written into the storage space of the internal memory 111 at different time points, and the weight data written each time overwrites the weight data written the previous time.

In an embodiment, the internal memory 111 may be recorded with all convolution kernels of the first convolutional layer, and then use all convolution kernels of the second convolutional layer to overwrite all the convolution kernels of the first convolutional layer. In an embodiment, the internal memory 111 may be recorded with a part of the convolution kernels of the first convolutional layer, and then use another part of the convolution kernels of the first convolutional layer or a part of the convolution kernels of the second convolutional layer to overwrite the part of the convolution kernels of the first convolutional layer.

In an embodiment, the internal memory 111 may be recorded with a part of a certain convolution kernel of the first convolutional layer, and then use another part of the certain convolution kernel of the first convolutional layer to overwrite the part of the certain convolution kernel of the first convolutional layer. Specifically, the internal memory 111 may obtain a part of the weight data of the first convolutional layer. The computing circuit 112 uses the part of the weight data of the first convolutional layer to execute the convolution computation of the first convolutional layer to obtain a first part calculation result. During a period when the computing circuit 112 is executing the convolution computation of the first convolutional layer to obtain the first part calculation result by using the part of the weight data of the first convolutional layer, the internal memory 111 may obtain another part of the weight data of the first convolutional layer from the external memory 120, so as to overwrite the part of the weight data of the first convolutional layer with the another part of the weight data of the first convolutional layer. In an embodiment, the weight data of the first convolutional layer is a convolution kernel having M channels, and the part of the weight data of the first convolutional layer is a weight value of N channels in the convolution kernel, where M is greater than N.

It should be noted that in the embodiment in which the weight data in a convolution kernel of the first convolutional layer is written into the internal memory 111 in batches, the computing circuit 112 may record the first part calculation result in the memory circuit 42. The computing circuit 112 uses another part of the weight data of the first convolutional layer to execute the convolution computation of the first convolutional layer to obtain a second part calculation result. The computing circuit 112 may obtain a convolution calculation result of the first convolutional layer by accumulating the first part calculation result and the second part calculation result.

The following describes different implementations of writing the weight data into the internal memory 111 in batches.

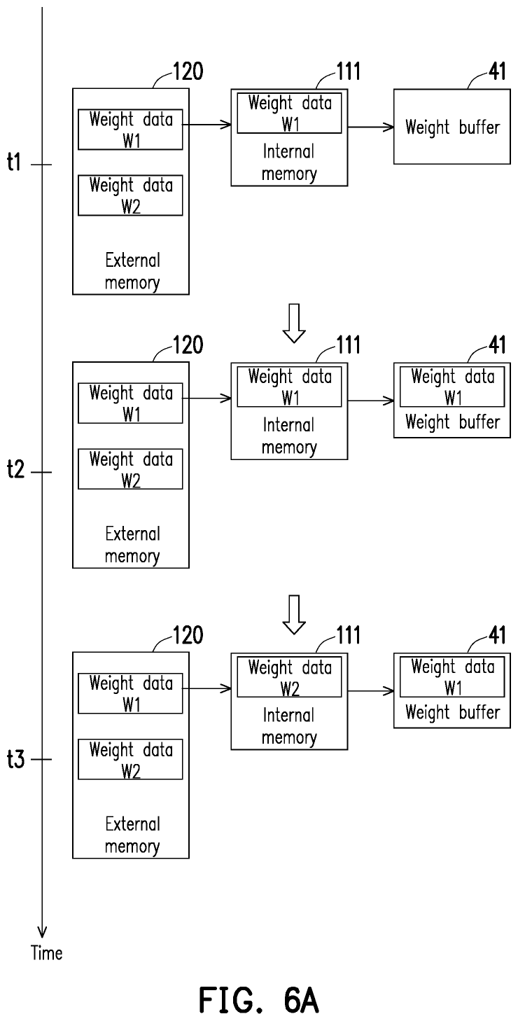

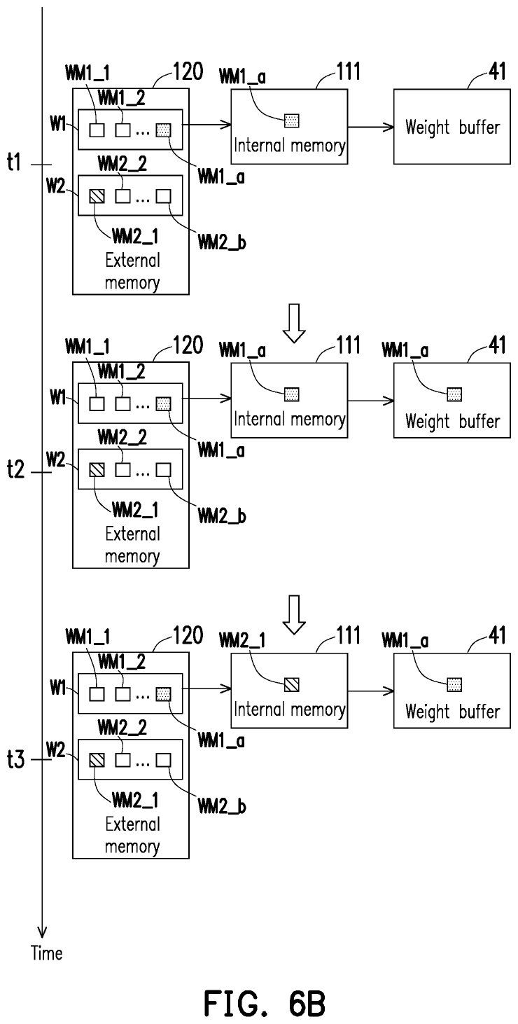

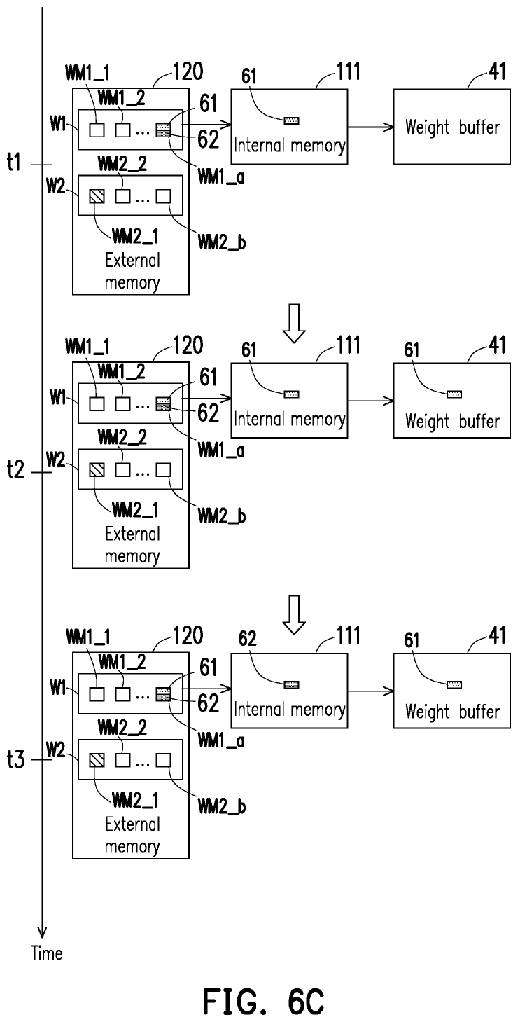

FIG. 6A is a schematic view of updating weight data in an internal memory according to an embodiment of the disclosure. Referring to FIG. 6A, the external memory 120 is recorded with weight data W1 of the first convolutional layer and weight data W2 of the second convolutional layer. The weight data W1 and the weight data W2 may respectively include a plurality of convolution kernels. At a time point t1, the internal memory 111 in the processing device 110 may obtain the weight data W1 of the first convolutional layer from the external memory 120. At a time point t2, the weight data W1 of the first convolutional layer in the internal memory 111 may be written into the weight buffer 41. After the operation of writing the weight data W1 of the first convolutional layer into the weight buffer 41 is completed, the computing circuit 112 may execute the convolution computation of the first convolutional layer according to the weight data W1 in the weight buffer 41. In addition, after the operation of writing the weight data W1 of the first convolutional layer into the weight buffer 41 is completed, at a time point t3, the internal memory 111 may obtain the weight data W2 of the second convolutional layer from the external memory 120, so as to overwrite the weight data W1 with the weight data W2.

FIG. 6B is a schematic view of updating weight data in an internal memory according to an embodiment of the disclosure. Referring to FIG. 6B, the external memory 120 is recorded with the weight data W1 of the first convolutional layer and the weight data W2 of the second convolutional layer. The weight data W1 may include a plurality of convolution kernels WM1_1 to WM1_a, and the weight data W2 may include a plurality of convolution kernels WM2_1 to WM2_b. At the time point t1, the internal memory 111 in the processing device 110 may obtain the convolution kernel WM1_a of the first convolutional layer from the external memory 120. At the time point t2, the convolution kernel WM1_a of the first convolutional layer in the internal memory 111 may be written into the weight buffer 41. After the operation of writing the convolution kernel WM1_a into the weight buffer 41 is completed, the computing circuit 112 may execute the convolution computation of the first convolutional layer according to the convolution kernel WM1_a in the weight buffer 41. In addition, after the operation of writing the convolution kernel WM1_a into the weight buffer 41 is completed, at the time point t3, the internal memory 111 may obtain the convolution kernel WM2_1 of the second convolutional layer from the external memory 120, so as to overwrite the convolution kernel WM1_a with the convolution kernel WM2_1.

FIG. 6C is a schematic view of updating weight data in an internal memory according to an embodiment of the disclosure. Referring to FIG. 6C, the external memory 120 is recorded with the weight data W1 of the first convolutional layer and the weight data W2 of the second convolutional layer. The weight data W1 may include the plurality of convolution kernels WM1_1 to WM1_a, and the weight data W2 may include the plurality of convolution kernels WM2_1 to WM2_b. At the time point t1, the internal memory 111 in the processing device 110 may obtain a part 61 of the convolution kernel WM1_a of the first convolutional layer from the external memory 120. The convolution kernel WM1_a has M channels, and the internal memory 111 may obtain weight values corresponding to a first channel to an N^{th} channel in the convolution kernel WM1_a of the first convolutional layer from the external memory 120. For example, in the embodiment, N may be equal to 1/2M, that is, a single convolution kernel is divided into two parts, but the disclosure is not limited thereto.

Next, at the time point t2, the part 61 of the convolution kernel WM1_a of the first convolutional layer in the internal memory 111 may be written into the weight buffer 41. After the operation of writing a part of the weight values of the convolution kernel WM1_a into the weight buffer 41 is completed, the computing circuit 112 may execute the convolution computation of the first convolutional layer according to the part 61 of the convolution kernel WM1_a in the weight buffer 41 and a first part feature map of an input feature map to obtain the first part calculation result, and record the first part calculation result in the memory circuit 42. In addition, after the operation of writing the part of the weight values of the convolution kernel WM1_a into the weight buffer 41 is completed, at the time point t3, the internal memory 111 may obtain another part 62 of the convolution kernel WM1_a of the first convolutional layer from the external memory 120, so as to overwrite the part 61 of the convolution kernel WM1_a with the another part 62 of the convolution kernel WM1_a.

Although not shown in FIG. 6C, after the computing circuit 112 completes the convolution computation between the part 61 of the convolution kernel WM1_a and a corresponding part of the input feature map, the another part 62 of the convolution kernel WM1_a of the first convolutional layer in the internal memory 111 may be written into the weight buffer 41. After that, the computing circuit 112 may execute the convolution computation of the first convolutional layer according to the another part 62 of the convolution kernel WM1_a in the weight buffer 41 and a second part feature map of the input feature map to obtain the second part calculation result. Therefore, the computing circuit 112 may obtain the convolution calculation result of the first convolutional layer by accumulating the first part calculation result associated with the part 61 of the convolution kernel WM1_a and the second part calculation result associated with the another part 62 of the convolution kernel WM1_a.

For example, it is assumed that the size of the convolution kernel WM1_a is H6*W6*D6, and the size of the part 61 of the convolution kernel WM1_a may be H6*W6*(D6/2). The computing circuit 112 may obtain the part 61 of the convolution kernel WM1_a from the weight buffer 41, and perform the convolution computation on the first part feature map according to the weight data in the size of H6*W6*(D6/2). A number of channels of the first part feature map is determined according to a number of channels of the part 61 of the convolution kernel WM1_a, which is H7*W7*(D6/2). In addition, the size of the part 62 of the convolution kernel WM1_a is also H6*W6*(D6/2). The computing circuit 112 may obtain the part 62 of the convolution kernel WM1_a from the weight buffer 41, and perform the convolution computation on the second part feature map according to the weight data in the size of H6*W6*(D6/2). A number of channels of the second part feature map is determined according to a number of channels of the part 62 of the convolution kernel WM1_a, which is H7*W7*(D6/2). However, FIG. 6C illustrates an example in which the weight values in the single convolution kernel WM1_a are evenly divided into two parts having the same size, but the disclosure is not limited thereto. In other embodiments, the weight values in a single convolution kernel may be divided into two or more parts, and the internal memory 111 may sequentially write a part of the convolution kernel from the external memory 120.

In summary, in the embodiments of the disclosure, when the processing device is in the process of executing the convolutional neural network computation, the weight data required for the convolutional neural network computation may be sequentially written into the internal memory of the processing device in batches. The internal memory disposed in the processing device may be sequentially overwritten with different batches of the weight data. Therefore, the storage capacity requirement of the internal memory disposed in the processing device may be reduced, thereby saving the hardware cost, the circuit area, and the power consumption of the processing device. In addition, by sequentially writing the weight data into the internal memory of the processing device in batches, even if a flash memory with a slower access rate is used as the external memory, the calculation efficiency of the processing device is not affected, thereby reducing the overall power consumption.

Finally, it should be noted that the above embodiments are only used to illustrate the technical solutions of the disclosure, but not to limit the disclosure. Although the disclosure has been described in detail with reference to the embodiments, persons of ordinary skill in the art should understand that modifications may be made to the technical solutions of the embodiments of the disclosure, or that some or all of the technical features may be equivalently replaced. However, the modifications or replacements do not cause the essence of the corresponding technical solutions to deviate from the scope of the technical solutions of the embodiments of the disclosure.

What is claimed is:

1. A processing device for executing convolutional neural network computation, wherein the convolutional neural network computation comprises a plurality of convolutional layers, the processing device comprising:
an internal memory; and
a computing circuit, coupled to the internal memory and executing convolution computation of each of the plurality of convolutional layers,
wherein the internal memory obtains weight data of a first convolutional layer in the plurality of convolutional layers from an external memory, and the computing circuit uses the weight data of the first convolutional layer to execute convolution computation of the first convolutional layer, and
during a period when the computing circuit is executing the convolution computation of the first convolutional layer, the internal memory obtains weight data of a second convolutional layer in the plurality of convolution layers from the external memory, so as to overwrite the weight data of the first convolutional layer with the weight data of the second convolutional layer.

2. The processing device according to claim 1, wherein the processing device further comprises a controller, and the controller controls the internal memory to obtain the weight data of the second convolutional layer from the external memory in response to a notification signal sent by the computing circuit.

3. The processing device according to claim 2, wherein the computing circuit comprises a weight buffer, and after the internal memory provides the weight data of the first convolutional layer to the weight buffer, the computing circuit sends the notification signal to the controller.

4. The processing device according to claim 1, wherein the weight data of the first convolutional layer comprises at least one convolution kernel of the first convolutional layer, and the computing circuit uses the weight data of the first convolutional layer to execute the convolution computation of the first convolutional layer to obtain at least one feature map corresponding to the at least one convolution kernel.

5. The processing device according to claim 1, wherein the internal memory obtains a part of the weight data of the first convolutional layer, and the computing circuit uses the part of the weight data of the first convolutional layer to execute the convolution computation of the first convolutional layer to obtain a first part calculation result,
wherein during a period when the computing circuit is executing the convolution computation of the first convolutional layer to obtain the first part calculation result by using the part of the weight data of the first convolutional layer, the internal memory obtains another part of the weight data of the first convolutional layer from the external memory, so as to overwrite the part of the weight data of the first convolutional layer with the another part of the weight data of the first convolutional layer.

6. The processing device according to claim 5, wherein the weight data of the first convolutional layer is a convolution kernel having M channels, and the part of the weight data of the first convolutional layer is a weight value of N channels in the convolution kernel, where M is greater than N.

7. The processing device according to claim 5, wherein the computing circuit records the first part calculation result in a memory circuit, the computing circuit uses the another part of the weight data of the first convolutional layer to execute the convolution computation of the first convolutional layer to obtain a second part calculation result, and the computing circuit obtains a convolution calculation result of the first convolutional layer by accumulating the first part calculation result and the second part calculation result.

8. The processing device according to claim 1, wherein the computing circuit is configured to analyze a fingerprint image or a palmprint image sensed by a fingerprint sensing device.

9. An operation method of a processing device for executing convolutional neural network computation, wherein the convolutional neural network computation comprises a plurality of convolutional layers, the operation method comprising:
obtaining weight data of a first convolutional layer in the plurality of convolutional layers from an external memory by an internal memory, and executing convolution computation of the first convolutional layer by using the weight data of the first convolutional layer by a computing circuit; and
obtaining weight data of a second convolutional layer in the plurality of convolution layers from the external memory by the internal memory during a period of executing the convolution computation of the first convolutional layer, so as to overwrite the weight data of the first convolutional layer with the weight data of the second convolution layer.

10. The operation method according to claim 9, wherein the step of obtaining the weight data of the second convolutional layer in the plurality of convolutional layers from the external memory by the internal memory comprises:
controlling the internal memory to obtain the weight data of the second convolutional layer from the external memory by the controller in response to a notification signal sent by the computing circuit.

11. The operation method according to claim 10, wherein the step of obtaining the weight data of the second convolutional layer in the plurality of convolutional layers from the external memory by the internal memory further comprises:
sending the notification signal to the controller by the computing circuit after the internal memory provides the weight data of the first convolutional layer to a weight buffer.

12. The operation method according to claim 9, wherein the weight data of the first convolutional layer comprises at least one convolution kernel of the first convolutional layer, and the computing circuit uses the weight data of the first convolutional layer to execute the convolution computation of the first convolutional layer to obtain at least one feature map corresponding to the at least one convolution kernel.

13. The operation method according to claim 9, wherein the step of obtaining the weight data of the first convolutional layer in the plurality of convolutional layers from the external memory by the internal memory, and executing the convolution computation of the first convolutional layer by using the weight data of the first convolutional layer by the computing circuit comprises:
obtaining a part of the weight data of the first convolutional layer by the internal memory, and executing the convolution computation of the first convolutional layer to obtain a first part calculation result by using the part of the weight data of the first convolutional layer by the computing circuit; and
obtaining another part of the weight data of the first convolutional layer by the internal memory during a period of executing the convolution computation of the first convolutional layer by using the part of the weight data of the first convolutional layer to obtain the first part calculation result, so as to overwrite the part of the weight data of the first convolutional layer with the another part of the weight data of the first convolutional layer.

14. The operation method according to claim 13, wherein the weight data of the first convolutional layer is a convolution kernel having M channels, and the part of the weight data of the first convolutional layer is a weight value of N channels in the convolution kernel, where M is greater than N.

15. The operation method according to claim 13, further comprising:
recording the first part calculation result in a memory circuit, and executing the convolution computation of the first convolutional layer to obtain a second part calculation result by using the another part of the weight data of the first convolutional layer by the computing circuit; and
obtaining a convolution calculation result of the first convolutional layer by accumulating the first part calculation result and the second part calculation result by the computing circuit.

16. The operation method according to claim 9, wherein the computing circuit is configured to analyze a fingerprint image or a palmprint image sensed by a fingerprint sensing device.
